(19) United States
(12) Patent Application Publication
(10) Pub. No.: US 2009/0096819 A1
(43) Pub. Date: Apr. 16, 2009

(54) DRIVING CIRCUIT APPARATUS

(75) Inventor: Hiroyuki Kinoshita, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/237,604

(22) Filed: Sep. 25, 2008

(30) Foreign Application Priority Data
Oct. 16, 2007 (JP) 2007269113

(51) Int. Cl. G09G 5/02; G09G 5/10

(52) U.S. Cl. 345/694; 345/690

(57) ABSTRACT

A driving circuit that reduces chip size of a source driver while maintaining image quality when image data is configured by multiple bits. The source driver provided in connection with a timing controller that converts image data into color data. The source driver displays an image by controlling pixel density of a liquid crystal panel. The source driver is divided into plural regions in units of pseudo linear elements to perform a gamma correcting operation based on a gamma characteristic. In the source driver a GMA voltage for each region is divided by resistive elements arranged between input signal lines. With respect to variation of plural divided GMA voltages, variation of the maximum high density region becomes coarser than variation of the maximum low density region in compliance with visual sensitivity of the density, thus reducing the number of input data lines of the source driver.

The present application claims priority under 35 U.S.C. 119 to Japanese patent application serial number 2007/269113, filed on Oct. 16, 2007, which is hereby incorporated by reference in its entirety for all purposes.

### BACKGROUND OF THE INVENTION

1. Field of the Invention

The present invention relates to a driving circuit apparatus, and more particularly to reducing chip size of a source driver in a liquid crystal driver circuit.

2. Description of the Related Art

In general, in a display method for a liquid crystal display (LCD), a timing controller receives image data output from a graphic processor or the like, transmits a line select signal to a gate driver, and outputs color data to a source driver. The source driver divides a GMA (Gamma) voltage, which represents a voltage value of a gray scale for a color, by resistors; provides a voltage depending on color data to a liquid crystal panel; and displays an image at lines selected by the gate driver from top to bottom. In this case, since the liquid crystal display has a unique gamma characteristic, an image is displayed on the liquid crystal display while performing a gamma correcting operation.

FIG. 7 is a configurational view 700 of a prior art source driver. As shown in the configurational view 700, the prior art source driver includes GMA1, GMA2, GMA3, GMA4, data lines (plural input data lines), a decoder 710, and an operational amplifier (hereinafter abbreviated as OP Amp) 720. The data lines include 4096 input data lines Ref0 to Ref4095 (representing 4096 gray scales), and the OP Amp 720 is used as a voltage follower circuit.

In addition, as shown in the configurational view 700 of the prior art source driver in FIG. 7, a range between GMA3 and GMA4 is defined as a seventh region 730 (including 1024 input data lines), a range between GMA2 and GMA3 is defined as an eighth region 740 (including 2048 input data lines), and a range between GMA1 and GMA2 is defined as a ninth region 750 (including 1024 input data lines), in all of which regions resistive elements are connected in series with fineness (or precision) of 12 bits.

FIG. 8 is a graph showing a unique gamma characteristic 800 of a prior art liquid crystal panel. The gamma characteristic graph 800 shows a gamma characteristic curve 810 wherein the horizontal axis represents input data (input data delivered to the input data lines Ref0 to Ref4095 in FIG. 7) and the vertical axis represents an output voltage (black being indicated by a low voltage side and white being indicated by a high voltage side).

Gamma correction may be provided using an analog scheme or a digital scheme. In the case of analog gamma correction, gamma correction is achieved by dividing a GMA voltage by resistors in the prior art source driver 700 shown in FIG. 7, so as to obtain the gamma characteristic 800 (gamma characteristic curve 810) in FIG. 8. In the case of digital gamma correction, in a timing controller of the prior art liquid crystal display, a gamma look-up table (LUT) for gamma correction is used, and gamma correction is made to image data input thereto and the gamma-corrected data is then output to a source driver. In this case, the source drivers are linear drivers that convert output data of the timing controller in a linear manner and that output the converted data to the liquid crystal panel.

The conventional source driver 700 shown in FIG. 7 divides a GMA voltage by resistors, provides a voltage depending on color data to the liquid crystal panel, and thus provides for display of an image at lines selected by a gate driver from top to bottom. In this case, since the liquid crystal display has the unique gamma characteristic 800 (gamma characteristic curve 810) as shown in FIG. 8 for every liquid crystal panel, an image is displayed on the liquid crystal display while performing a gamma correcting operation.

In the meantime, Japanese Patent Application Publication No. 2002-175060 discloses a liquid crystal display device for a portable terminal that is small in size and low in power consumption, by preventing rounding of a driving waveform. The portable terminal is realized without the need to provide an output circuit for every output terminal to a liquid crystal panel. The liquid crystal display device includes a ladder resistance circuit for generating a voltage for gamma correction.

In addition, Japanese Patent Application Publication No. 2003-233354 discloses a reference voltage generation circuit, a display driving circuit, a display device and a reference voltage generation method which are generally used irrespective of the kind of display device, without increasing circuit scale. The reference voltage generation circuit includes a ladder resistance circuit for generating a voltage for gamma correction.

However, if image data is configured by multiple bits (multi-gradation) for either an analog gamma correction or a digital gamma correction, this leads to an increase in the number of data lines of a source driver. With recent progress toward multi-channeling of a source driver, such an increase in the number of data lines has a great effect on increasing chip size.

### SUMMARY OF THE INVENTION

In order to solve the above problems, it is an object of the present invention to provide a driving circuit apparatus which is capable of reducing chip size of a source driver, while maintaining image quality even when image data is configured by multiple bits.

According to a first aspect of the present invention, for attaining the above object, there is provided a driving circuit apparatus having a color density data conversion unit that converts image data into color density data and for displaying an image by controlling color density of pixels arranged in a matrix, wherein a relationship between the image data at an input side of the color density data conversion unit and the color density data at an output side of the color density data conversion unit is nonlinear, the driving circuit apparatus is divided into plural regions in units of pseudo linear elements, and at least a resolution of a maximum high density region is set to be higher than a resolution of a maximum low density region in compliance with visual sensitivity of the color density.

According to a second aspect of the present invention for attaining the above object, there is provided a driving circuit apparatus having a color density data conversion unit that converts image data into color density data and for displaying an image by controlling density of pixels arranged in a matrix, including a region dividing unit that divides the driving circuit apparatus into plural regions in units of pseudo linear elements in order to perform a gamma correcting operation based on a nonlinear unique gamma characteristic representing a relationship between the color data and driving voltages representing color gray scales depending on the color data; a driving voltage dividing unit that divides the driving voltages for each of the regions by resistors; a driving voltage variation setting unit that, with respect to variation of the driving voltages divided by the resistors by the driving voltage dividing unit, makes at least variation of a maximum high density region coarser than variation of a maximum low density region in compliance with visual sensitivity of the density of pixels; a driving voltage selecting unit that selects one driving voltage from the driving voltages set by the driving voltage dividing unit; and a control unit that controls the density of pixels based on the driving voltage selected by the driving voltage selecting unit.

In the above noted first and second aspects of the present invention, the unique gamma characteristic for the pixels is reflected on the color data at the output side of the color density data conversion unit based on a predetermined look-up table.

As described above, according to the present invention, it is possible to provide a driving circuit apparatus which is capable of achieving reduction in chip size of a source driver by reducing the number of data lines within the source driver, while maintaining image quality even when an image data is configured by multiple bits.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram illustrating a configuration of a liquid crystal display according to a first embodiment of the present invention;

FIG. 2 is a first configurational view of a source driver according to the first embodiment of the present invention;

FIG. 3 is a graph showing a unique analog gamma characteristic of a liquid crystal panel shown in FIG. 1 according to the first embodiment of the present invention;

FIG. 4 is a graph showing a unique analog gamma characteristic of a liquid crystal panel shown in FIG. 1 according to a second embodiment of the present invention;

FIG. 5 is a graph showing a digital gamma characteristic (gamma LUT) of a linear source driver, which is converted based on the gamma characteristic shown in FIG. 4 according to the second embodiment of the present invention;

FIG. 6 is a diagrammatic view illustrating a second configuration of a source driver according to the second embodiment of the present invention;

FIG. 7 is a diagrammatic view illustrating a configuration of a prior art source driver; and

FIG. 8 is a graph showing a gamma characteristic of a liquid crystal panel of the prior art.

### DESCRIPTION OF THE PREFERRED EMBODIMENTS

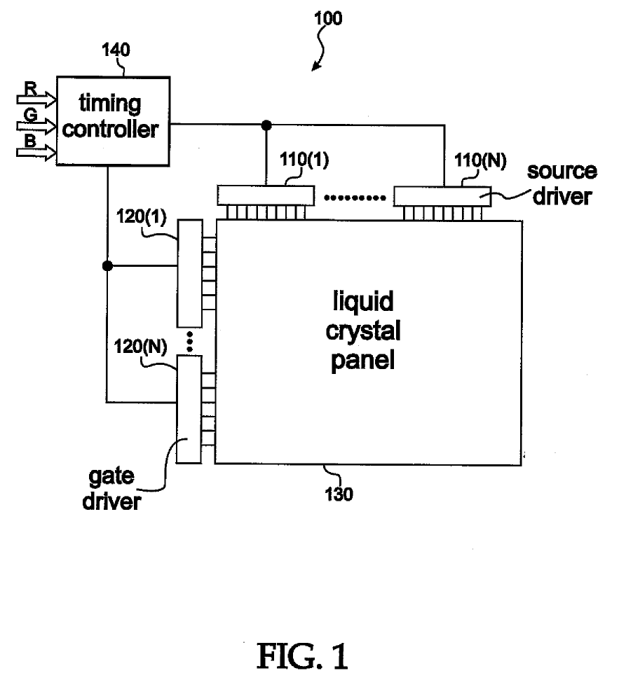

FIG. 1 is a configurational view of a liquid crystal display 100 according to a first embodiment of the present invention. Liquid crystal display (LCD) 100 includes a timing controller 140, source drivers 110(1), . . . , 110(N) (N is an integer of more than 1), gate drivers 120(1), . . . , 120(N), and a liquid crystal panel 130. Hereinafter, the source drivers 110(1), . . . , 110(N) may be sometimes generally called a source driver 110 as a single unit, and similarly the gate drivers 120(1), . . . , 120(N) may be sometimes generally called a gate driver 120. The timing controller 140 is connected to the source drivers 110(1), . . . , 110(N) and the gate drivers 120(1), . . . , 120(N). The source drivers 110(1), . . . , 110(N) and the gate drivers 120(1), . . . , 120(N) are connected to the liquid crystal panel 130.

In a display method of the LCD 100, the timing controller 140 receives image data including an RGB (Red-Green-Blue) signal output from a graphic processor or the like, transmits a line select signal to the gate drivers 120(1), . . . , 120(N), and outputs color data to the source drivers 110(1), . . . , 110(N). The source drivers 110(1), . . . , 110(N) divide GMA voltages which represent voltage values of color gray scales by using resistors, provide GOMA voltages depending on the color data to the liquid crystal panel, and thus provide for display of an image at lines selected by the gate drivers 120(1), . . . , 120(N) from top to bottom. In this case, since the LCD 100 has a unique gamma characteristic, an image is displayed on the LCD 100 while performing a gamma correcting operation. In this embodiment, the source drivers are a driving circuit (driving circuit apparatus).

Gamma correction refers to a correcting operation for obtaining an image as naturally as possible by adjusting a relative relation between color data of an image and signals when the data are actually output. In more detail, a gamma value refers to a ratio of variation of a voltage conversion value to variation of image brightness, which ideally approximates 1 although it may be varied with different devices having different characteristics. Therefore, there is a need to correct such errors (variation) for substantial reproducibility of display of original data. This is the gamma correction.

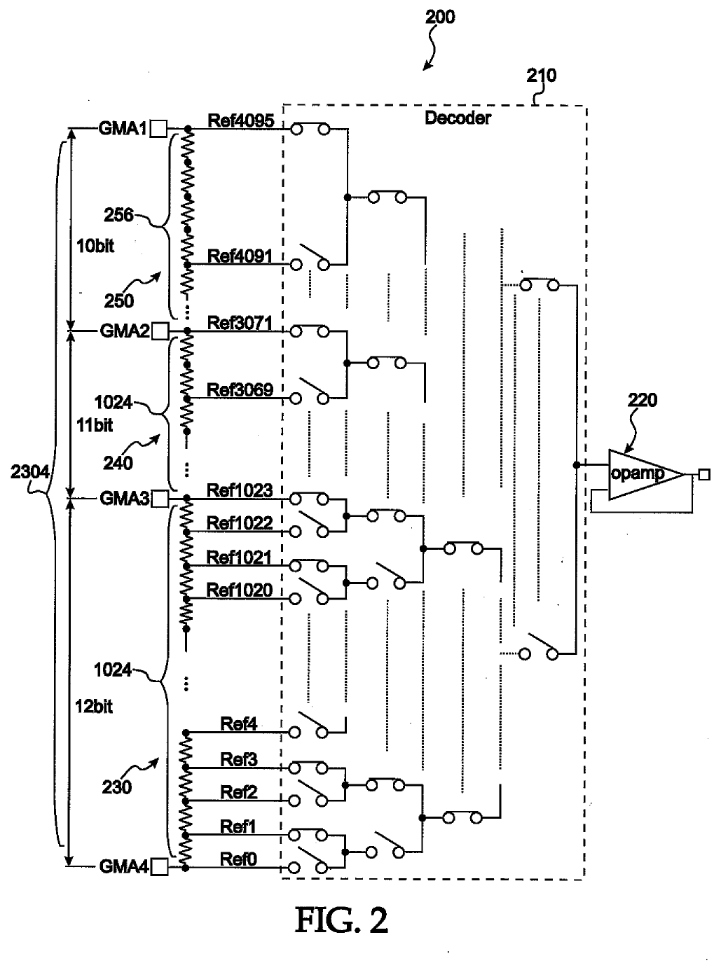

FIG. 2 is a first configurational view 200 of the source driver 110 according to the first embodiment of the present invention. As shown in the first configurational view 200, the source driver 110 includes GMA1, GMA2, GMA3, GMA4, data lines (plural input data lines), a decoder 210, and an operational amplifier (hereinafter abbreviated as OP Amp) 220. The data lines include 2304 input data lines Ref0 to Ref4095 (representing 2304 gray scales) (excluding 1791 unused input data lines having no wiring), and the OP Amp 220 is used as a voltage follower circuit. In addition, as shown in the first configurational view 200 in FIG. 2, a range between GMA3 and GMA4 with fineness of 12 bits is defined as a first region 230, a range between GMA2 and GMA3 with fineness of 11 bits is defined as a second region 240, and a range between GMA1 and GMA2 with fineness of 10 bits is defined as a third region 250, in all of which regions resistive elements are connected in series.

In more detail, 1024 input signal lines Ref0 to Ref1023 in the first region 230 are connected to the decoder 210. 1024 input signal lines Ref1023, Ref1025, . . . , Ref3069 and Ref3071 (arranged at intervals of one line) in the second region 240 are connected to the decoder 210. 256 input signal lines Ref3071, Ref3075, . . . , Ref4091 and Ref4095 (arranged at intervals of three lines) in the third region 250 are connected to the decoder 210. Also, the decoder 210 includes MOS (Metal Oxide Semiconductor) transistors or transmission gates as analog switches such that one of 2304 input data lines is selected.

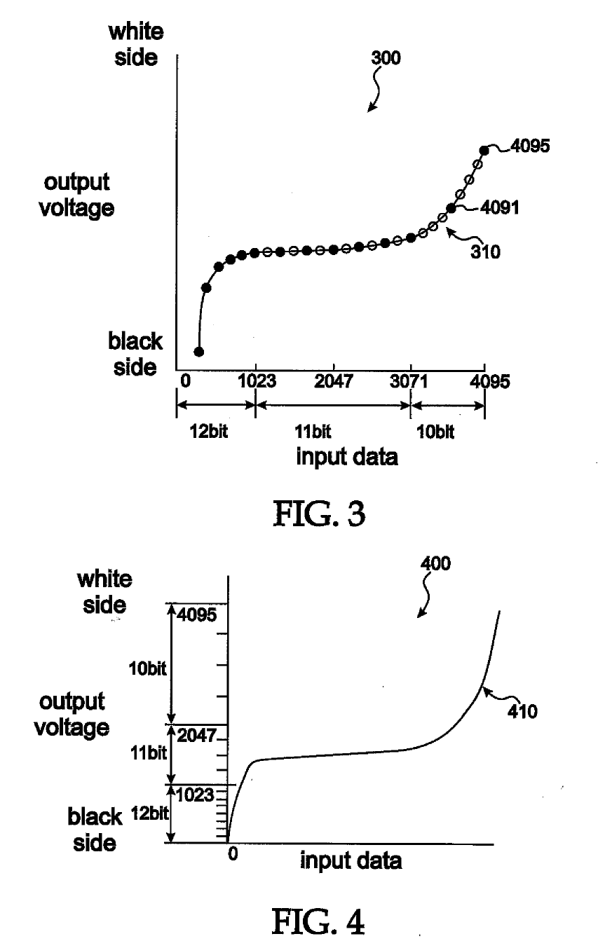

FIG. 3 is a graph showing a unique analog gamma characteristic 300 in the liquid crystal panel 130 shown in FIG. 1, according to the first embodiment of the present invention. The gamma characteristic graph 300 shows a gamma characteristic curve 310 wherein the horizontal axis represents input data (input data delivered to the input data lines Ref0 to Ref4095 in FIG. 2) and the vertical axis represents an output voltage (black being indicated by a low voltage side and white being indicated by a high voltage side).

As can be seen from the gamma characteristic curve 310 shown in FIG. 3, for each of the first region 230 with fineness of 12 bits, the second region 240 with fineness of 11 bits, and the third region 250 with fineness of 10 bits, the input data are thinned out in turn. In more detail for example, input signals input to the input signal lines Ref4095 and Ref4091 are indicated by a black circle and the input signal lines Ref4092 to Ref4094 having no wiring between the input signal lines Ref4095 and Ref4091 are indicated by a white circle. In other words, the gamma characteristic curve 310 has higher gradation with more black circles indicative of input signals at the low voltage black side than at the high voltage white side.

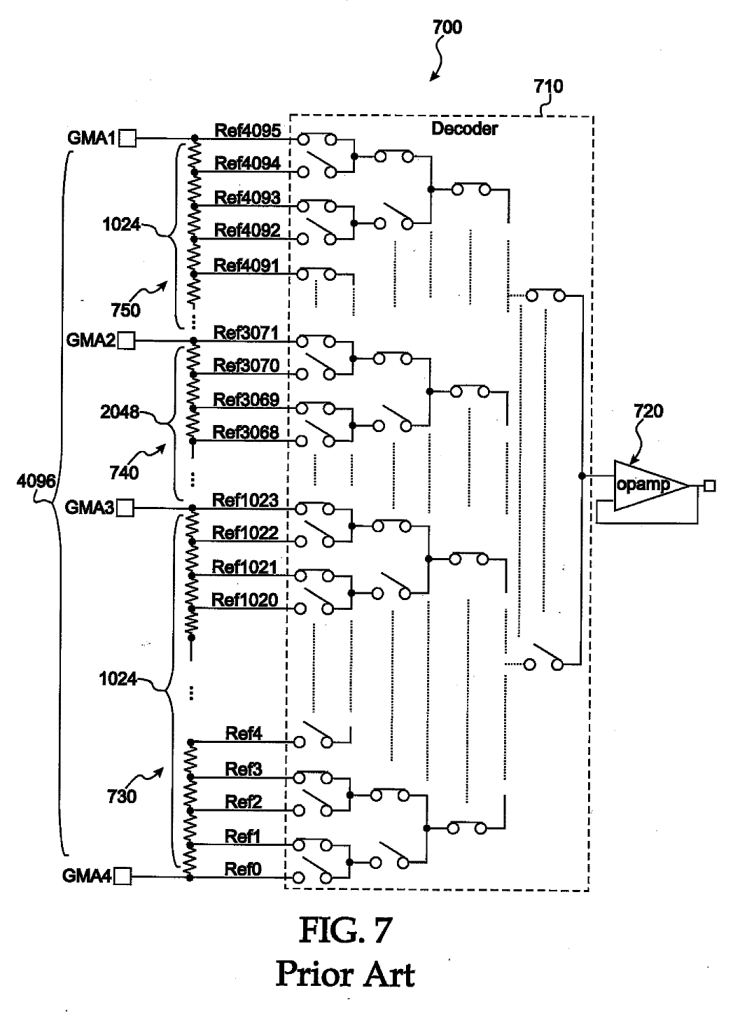

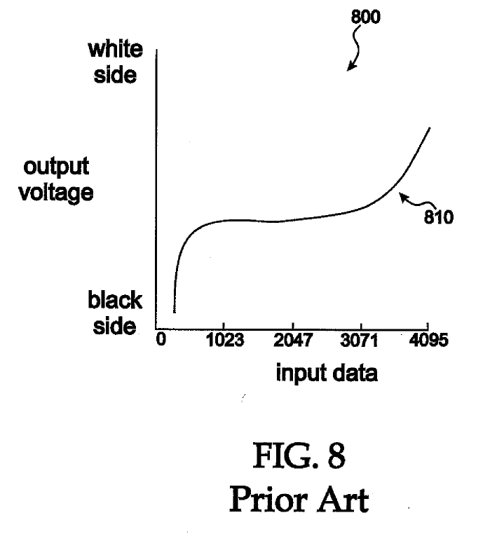

Hereinafter, an operation of the first embodiment of the present invention will be described. The resistive elements in the source driver 110 of the first embodiment are interconnected in series to divide the GMA voltage, and are connected to the data lines (plural input data lines). A resistance division ratio is set such that the gamma characteristic shown in FIG. 3 is obtained. The input data lines Ref0 to Ref1023 have fineness of 12 bits, the input data lines Ref1023 to Ref3071 have fineness of 11 bits, and the input data lines Ref3071 to Ref4095 have fineness of 10 bits. In more detail, the fineness of 12 bits for the input data lines Ref0 to Ref1023 correspond one-for-one with 1024 input data lines Ref0 to Ref1023 with the fineness 12 bits in the prior art shown in FIG. 7. In addition, the fineness of 11 bits for the input data lines Ref1023 to Ref3071 correspond to 1024 input data lines (2048 input data lines in the prior art in FIG. 7) thinned out of the input data lines Ref1023 to Ref3071 at intervals of one line, unlike the fineness of 12 bits in the prior art shown in FIG. 7. In addition, the fineness of 10 bits for the input data lines Ref3071 to Ref4095 correspond to 256 input data lines (1024 input data lines in the prior art in FIG. 7) thinned out of the input data lines Ref3071 to Ref4095 at intervals of three lines, unlike the fineness of 12 bits in the prior art shown in FIG. 7.

When GMA voltages are transmitted as input data through the respective input data lines Ref0 to Ref4095 shown in FIG. 2, the decoder 210 selects one of the input data and the OP Amp 220 amplifies and outputs the selected input data.

In more detail, the source driver 110 shown in FIG. 2 is provided as in connection with the timing controller that converts image data (RGB signals) into color data, and source driver 110 provides for display of an image by controlling pixel density of the liquid crystal panel 130 composed of pixels arranged in the form of a matrix based on the color data. In this case, in order to perform the gamma correcting operation based on the nonlinear unique gamma characteristic 300 (gamma characteristic curve 310) showing a relationship between the color data and driving voltages (GMA voltages) representing color gray scales depending on the color data, the source driver 110 is divided into plural regions in units of pseudo linear elements. In addition, a GMA voltage for each region is divided by the resistive elements arranged between the input signal lines, and regarding variation of plural divided GMA voltages, at least variation of the maximum high density region becomes coarser than variation of the maximum low density region in compliance with visual sensitivity of the density. One driving voltage is selected from the plural GMA voltages set in compliance with the visual sensitivity of the density, and an image is displayed on the liquid crystal panel 130 by controlling the pixel density of the liquid crystal panel 130 based on the selected GMA voltage. In addition, it should be understood that at least the resolution of the maximum high density region becomes higher than the resolution of the maximum low density region in compliance with the visual sensitivity of the color density.

That is, considering the property that human eyes are sensitive to a luminance difference in a screen close to black while being insensitive to a bright screen (screen close to white), ticking of the input data becomes coarse as a color goes from a black side (a lower side of input data) to a white side (an upper side of input data). The data lines in FIG. 2 are connected to the decoder 210 and an output of the decoder 210 is provided to the liquid crystal panel 130 via the OP Amp 220.

In more detail, in the configuration of the source driver 200 shown in FIG. 2, when the image data are input, the decoder 210 decodes the input image data, and accordingly a corresponding one of the data lines is selected. A voltage according to the selected data line is input to the OP Amp 220, and then is output to the liquid crystal panel 130. For example, since the input data lines are uniformly divided by resistors, voltages are varied by resistances from up to 15 V for GMA1 to 0 V for GMA4.

In addition, since it becomes important when a halftone (corresponding to the second region 240 between GMA2 and GMA3) is a full color, the resolution of the halftone may be increased in precision and may be mixed with the resolution of low gray scales (corresponding to the first region 230 between GMA3 and GMA4).

Accordingly, in accordance with the first embodiment, for example in a 12-bit source driver, the number of input data lines of the source driver becomes 2304 (=1024×1+2048×1/2+1024×1/4). As a result, since the number of input data lines can be significantly reduced as compared to a conventional 12-bit source driver requiring 4096 input data lines, it is possible to reduce chip area of the source driver.

That is, using the property that human eyes are sensitive to a luminance difference in a screen close to black while being insensitive to a bright screen (screen close to white), since ticking of the input data becomes coarse as a color goes from a black side (a lower side of input data) to a white side (an upper side of input data), the number of input data lines of the source driver can be reduced, thereby making it possible to reduce the chip size of the source driver while maintaining image quality, as compared to the prior art shown in FIG. 7.

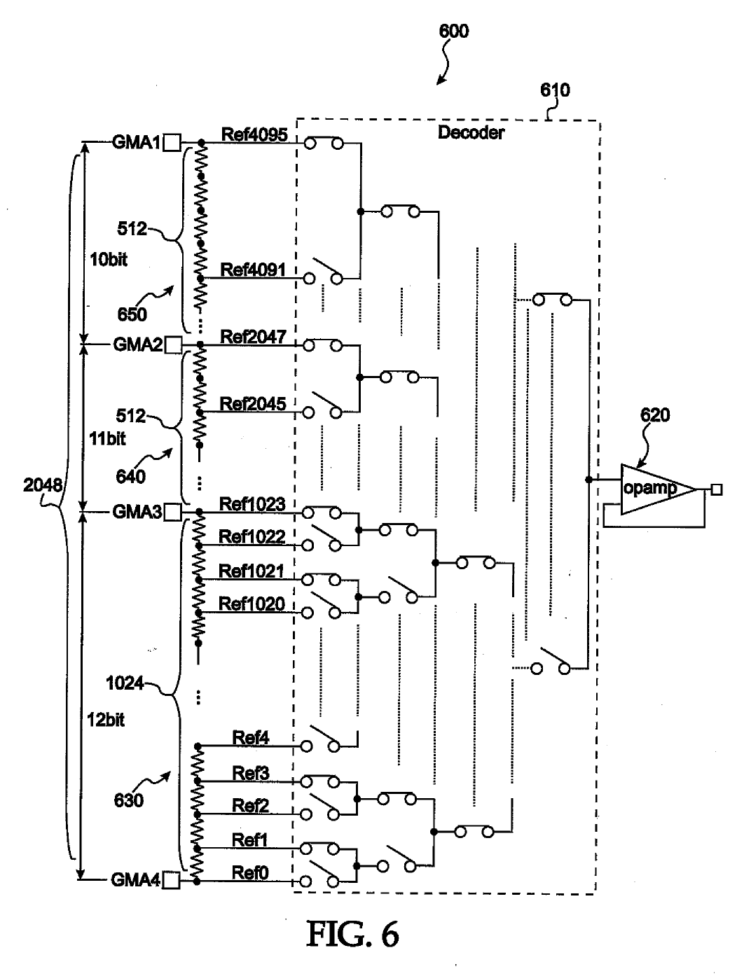

FIG. 6 is a second configurational view 600 of a source driver 110 according to a second embodiment of the present invention. As shown in the second configurational view 600, the source driver 110 includes GMA1, GMA2, GMA3, GMA4, data lines (plural input data lines), a decoder 610, and an operational amplifier (hereinafter abbreviated as OP Amp) 620. The data lines include 2048 input data lines Ref0 to Ref4095 (representing 2048 gray scales) (excluding 2047 unused input data lines having no wiring), and the OP Amp 620 is used as a voltage follower circuit.

In addition, as shown in the second configurational view 600 in FIG. 6, a range between GMA3 and GMA4 with fineness of 12 bits is defined as a fourth region 630, a range between GMA2 and GMA3 with fineness of 11 bits is defined as a fifth region 640, and a range between GMA1 and GMA2 with fineness of 10 bits is defined as a sixth region 650, in all of which regions resistive elements are connected in series.

In more detail, 1024 input signal lines Ref0 to Ref1023 in the fourth region 630 are connected to the decoder 610. 512 input signal lines Ref1023, Ref1025, . . . , Ref2045 and Ref2047 (arranged at intervals of one line) in the fifth region 640 are connected to the decoder 610. 512 input signal lines Ref2047, Ref2051, . . . , Ref4091 and Ref4095 (arranged at intervals of three lines) in the sixth region 650 are connected to the decoder 610. The decoder 610 includes MOS transistors or transmission gates as analog switches, which are controlled by the gate driver 120, such that one of 2048 input data lines is selected.

FIG. 4 is a graph showing a unique analog gamma characteristic 400 in the liquid crystal panel 130 shown in FIG. 1 according to the second embodiment of the present invention. The gamma characteristic graph 400 shows a gamma characteristic curve 410 wherein a horizontal axis represents input data (input data delivered to the input data lines Ref0 to Ref4095 in FIG. 6) and a vertical axis represents output data (output data corresponding to the respective input data).

As can be seen from the gamma characteristic curve 410 in FIG. 4, for each of the fourth region 630 with fineness of 12 bits, the fifth region 640 with fineness of 11 bits, and the sixth region 650 with fineness of 10 bits, the input data are thinned out in turn. The input image data are converted according to the gamma characteristic 400 shown in FIG. 4. At that time, a black side (a lower side of output data) is minutely converted with ticking of 12 bits and a white side (an upper side of output data) is converted with coarse ticking.

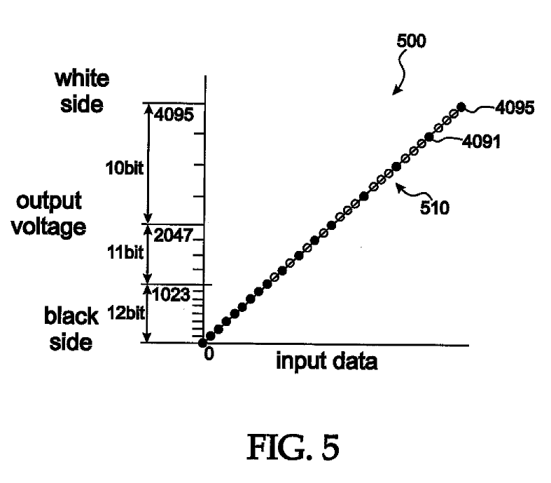

FIG. 5 is a graph showing a digital gamma characteristic (gamma LUT) 500 of a linear source driver, which is converted based on the gamma characteristic 400 shown in FIG. 4 according to the second embodiment of the present invention. The gamma LUT graph 500 shows a gamma characteristic curve 510 wherein a horizontal axis represents input data (input data delivered to the input data lines Ref0 to Ref4095 in FIG. 6) and a vertical axis represents output voltages (linear output voltages corresponding to the respective input data).

As can be seen from the gamma characteristic curve 510 in FIG. 5, for each of the fourth region 630 with fineness of 12 bits, the fifth region 640 with fineness of 11 bits, and the sixth region 650 with fineness of 10 bits, the input data are linearly thinned out in turn. In more detail for example, input signals input to the input signal lines Ref4095 and Ref4091 are indicated by a black circle and the input signal lines Ref4092 to Ref4094 having no wiring between the input signal lines Ref4095 and Ref4091 are indicated by a white circle.

Hereinafter, an operation of the second embodiment of the present invention will be described. The second embodiment of the present invention involves performing the gamma correction operation performed in the first embodiment, as described earlier, using the gamma LUT 500 (gamma characteristic curve 510) included in the timing controller 140.

The input data lines Ref0 to Ref1023 have fineness of 12 bits, the input data lines Ref1023 to Ref2047 have fineness of 11 bits, and the input data lines Ref2047 to Ref4095 have fineness of 10 bits. In more detail, the fineness of 12 bits for the input data lines Ref0 to Ref1023 correspond one-for-one with 1024 input data lines Ref0 to Ref1023 with the fineness 12 bits in the prior art shown in FIG. 7. In addition, the fineness of 11 bits for the input data lines Ref1023 to Ref2047 correspond to 512 input data lines (2048 input data lines in the prior art in FIG. 7) thinned out of the input data lines Ref1023 to Ref2047 at intervals of one line, unlike the fineness of 12 bits in the prior art shown in FIG. 7. In addition, the fineness of 10 bits for the input data lines Ref2047 to Ref4095 correspond to 512 input data lines (1024 input data lines in the prior art in FIG. 7) thinned out of the input data lines Ref2047 to Ref4095 at intervals of three lines, unlike the fineness of 12 bits in the prior art shown in FIG. 7.

When GMA voltages are transmitted as input data through the respective input data lines Ref0 to Ref4095, the decoder 610 selects one of the input data and the OP Amp 620 amplifies and outputs the selected input data.

In more detail, the source driver 110 is provided in connection with the timing controller that converts image data (RGB signals) into color data, and source driver 110 provides for display of an image by controlling pixel density of the liquid crystal panel 130 based on the color data. In this case, in order to perform the gamma correcting operation for color data at an output side based on the gamma LUT 500 (gamma characteristic curve 510) which is a conversion of the gamma characteristic 400 (gamma characteristic curve 410) showing a relationship between the color data and GMA voltages representing color gray scales depending on the color data, the source driver 110 is divided into plural regions in units of pseudo linear elements. In addition, a GMA voltage for each region is divided by the resistive elements arranged between the input signal lines, and regarding variation of plural divided GMA voltages, at least variation of the maximum high density region becomes coarser than variation of the maximum low density region in compliance with visual sensitivity of the density. One driving voltage is selected from the plural GMA voltages set in compliance with the visual sensitivity of the density, and an image is displayed on the liquid crystal panel 130 by controlling the pixel density of the liquid crystal panel 130 based on the selected GMA voltage. In addition, it should be understood that at least the resolution of the maximum high density region becomes higher than the resolution of the maximum low density region in compliance with the visual sensitivity of the color density.

That is, considering the property that human eyes are sensitive to a luminance difference in a screen close to black while being insensitive to a bright screen (screen close to white), ticking of the input data becomes coarse as a color goes from a black side (a lower side of input data) to a white side (an upper side of input data). In addition, in the second embodiment of the present invention, a linear source driver is used as the source driver. A linear source driver refers to a source driver whose output voltage has a linear characteristic for the input data, as shown in FIG. 5, by equalizing a voltage dividing ratio of resistors in the source driver in the prior art shown in FIG. 7 (i.e., by making all the resistors equal).

Since the linear source driver employed in the second embodiment of the present invention makes ticking of the output data coarse according to the gamma LUT 500 (gamma characteristic curve 510) as a color goes from a black side (a lower side of output data) to a white side (an upper side of output data), a relationship between the input data and the output voltages is as shown in FIG. 5, and the configuration of the linear source driver is as shown in FIG. 6. The linear source driver, which receives the data gamma-corrected according to the gamma LUT, outputs the received data to the liquid crystal panel 130 linearly.

In addition, like the first embodiment of the present invention, since the input data lines are uniformly divided by the resistive elements connected in series, voltages are varied by resistances from up to 15 V for GMA1 to 0 V for GMA4.

Also, since it becomes important when a halftone (corresponding to the second region 640 between GMA2 and GMA3) is a full color, the resolution of the halftone may be increased in precision and may be mixed with the resolution of low gray scales (corresponding to the first region 630 between GMA3 and GMA4).

Accordingly, in accordance with the second embodiment, for example in a 12 bit source driver, the number of input data lines of the source driver becomes 2048 (=1024×1+1024×1/2+2048×1/4), as shown in FIG. 6. As a result, since the number of input data lines can be significantly reduced as compared to a conventional gamma LUT requiring 4096 input data lines, it is possible to reduce a chip area of the source driver.

That is, using the property that human eyes are sensitive to a luminance difference in a screen close to black while being insensitive to a bright screen (screen close to white), on the basis of the gamma LUT included in the timing controller that makes ticking of the input data coarse as a color goes from a black side (a lower side of output data) to a white side (an upper side of output data), the number of input data lines of the source driver can be reduced, thereby making it possible to reduce the chip size of the source driver while maintaining image quality, as compared to the prior art shown in FIG. 7.

What is claimed is:

1. A driving circuit apparatus having a color density data conversion unit that converts image data into color density data and for displaying an image by controlling color density of pixels arranged in a matrix,
wherein a relationship between the image data at an input side of the color density data conversion unit and the color density data at an output side of the color density data conversion unit is nonlinear, the driving circuit apparatus is divided into plural regions in units of pseudo linear elements, and at least a resolution of a maximum high density region is set to be higher than a resolution of a maximum low density region in compliance with visual sensitivity of the color density.

2. The driving circuit apparatus according to claim 1, wherein a unique gamma characteristic for the pixels is reflected on the color data at the output side of the color density data conversion unit based on a predetermined look-up table.

3. A driving circuit apparatus having a color density data conversion unit that converts image data into color density data and for displaying an image by controlling density of pixels arranged in a matrix, comprising:
a region dividing unit that divides the driving circuit apparatus into plural regions in units of pseudo linear elements in order to perform a gamma correcting operation based on a nonlinear unique gamma characteristic representing a relationship between the color data and driving voltages representing color gray scales depending on the color data;
a driving voltage dividing unit that divides the driving voltages for each of the regions by resistors;
a driving voltage variation setting unit that, with respect to variation of the driving voltages divided by the resistors by the driving voltage dividing unit, makes at least variation of a maximum high density region coarser than variation of a maximum low density region in compliance with visual sensitivity of the density of pixels;
a driving voltage selecting unit that selects one driving voltage from the driving voltages set by the driving voltage dividing unit; and
a control unit that controls the density of pixels based on the driving voltage selected by the driving voltage selecting unit.

4. The driving circuit apparatus according to claim 3, wherein the unique gamma characteristic for the pixels is reflected on the color data at the output side of the color density data conversion unit based on a predetermined look-up table.

5. A driving circuit for displaying an image by controlling color density of pixels on a display, comprising:
a timing control circuit that converts received image data into color data to provide gamma voltages;
a gamma correction circuit including a network of resistance elements connected together in series, the gamma voltages being coupled to connecting nodes between the resistance elements, and predetermined ones of the connecting nodes providing driving voltages that are gamma corrected for output from the gamma correction circuit via data lines; and
a decoder coupled to the gamma correction circuit, that receives the driving voltages along the data lines and selects a driving voltage from the driving voltages for output to the display,
wherein differences between the driving voltages provided from adjacent ones of the data lines at a first end of the network of resistance elements are larger than differences between the driving voltages provided from adjacent ones of the data lines at a second end of the network of resistance elements.

6. A driving circuit for displaying an image by controlling color density of pixels on a display, comprising:
a timing control circuit that converts received image data into color data to provide gamma voltages;
a gamma correction circuit including a network of resistance elements connected together in series, the gamma voltages being coupled to connecting nodes between the resistance elements, and predetermined ones of the connecting nodes providing driving voltages that are gamma corrected for output from the gamma correction circuit via data lines; and
a decoder coupled to the gamma correction circuit, that receives the driving voltages along the data lines and selects a driving voltage from the driving voltages for output to the display,
wherein differences between the driving voltages provided from adjacent ones of the data lines at a first end of the network of resistance elements are larger than differences between the driving voltages provided from adjacent ones of the data lines at a second end of the network of resistance elements, and
wherein the driving voltages at the first end of the network of resistance elements are greater than the driving voltages at the second end of the network of resistance elements, so that the driving voltages that correspond to high density color have higher gradation than the driving voltages that correspond to low density color.
